(19) United States
(12) Patent Application Publication
(10) Pub. No.: US 2025/0137142 A1
(43) Pub. Date: May 1, 2025

(54) CORROSION INHIBITOR FOR MILD STEEL IN CIRCULATING WATER SYSTEMS

(71) Applicant: Halliburton Energy Services, Inc., Houston, TX (US)

(72) Inventors: Stanislav Barskov, Houston, TX (US); David Fulmer, Houston, TX (US); Richard Fruit, Houston, TX (US); Nathan Thachankary, Houston, TX (US)

(21) Appl. No.: 18/385,966

(22) Filed: Nov. 1, 2023

(51) Int. Cl. C23F 11/173

(52) U.S. Cl. CPC C23F 11/173

(57) ABSTRACT

A method of inhibiting corrosion in a circulating water system by adding a corrosion inhibitor consisting essentially of a phosphate-free corrosion inhibitor (PFCI) comprising a polymaleic acid copolymer and optionally a metal to a circulating water stream in the circulating water system.

### TECHNICAL FIELD

The present disclosure relates generally to circulating water systems and, more particularly, to corrosion inhibitors for such circulating water systems.

### BACKGROUND

Since the 1980s, phosphate-based corrosion inhibitors have been the primary means for protecting carbon steel equipment in circulating cooling water systems. Their low cost, lower toxicity relative to chromate and excellent effectiveness at a wide range of operating conditions have made them the inhibitors of choice for most industrial water treatment companies. The drawback of the phosphate-based inhibitors is that they require the addition of polymeric dispersants for calcium phosphate scale control, thus significantly increasing the overall treatment cost. The cost of the phosphate rock is elevated, phosphate rock mined in the U.S. continues to decline and the global phosphate rock production will likely be influenced by other countries. Phosphate discharges can also impact the downstream ecosystem by promoting unwanted algae and biological growth. A global phosphate shortage and the increasing cost of phosphate-based corrosion inhibitors continue to stress supply chains and phosphate-free corrosion inhibitors are becoming more attractive to the end user.

### BRIEF SUMMARY OF THE DRAWINGS

For a more complete understanding of this disclosure, reference is now made to the following brief description, taken in connection with the accompanying drawings and detailed description, wherein like reference numerals represent like parts.

FIG. 1 is a flow diagram of a method I, according to embodiments of this disclosure;

FIG. 2 is a schematic of a circulating fluid system II, according to embodiments of this disclosure;

FIG. 3 is a schematic of chemical structures and reactions related to an enhanced copolymer according to embodiments of this disclosure;

FIG. 4A is a side view of the blank coupon of The Example;

FIG. 4B is an end view of the blank coupon of The Example;

FIG. 4C is a corrosion rate curve for the blank coupon of The Example;

FIG. 5A is a side view of coupon Test ID #3 of The Example;

FIG. 5B is an end view of coupon Test ID #3 of The Example;

FIG. 5C is a corrosion rate curve for coupon Test ID #3 of The Example;

FIG. 6A is a side view of coupon Test ID #11 of The Example;

FIG. 6B is an end view of coupon Test ID #11 of The Example; and

FIG. 6C is a corrosion rate curve for coupon Test ID #11 of The Example.

While embodiments of this disclosure are depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time consuming but would nevertheless be a routine undertaking for those of ordinary skill in the art having the benefit of the present disclosure.

Throughout this disclosure, a reference numeral followed by an alphabetical character refers to a specific instance of an element and the reference numeral alone refers to the element generically or collectively. Thus, as an example (not shown in the drawings), widget “la” refers to an instance of a widget class, which may be referred to collectively as widgets “1” and any one of which may be referred to generically as a widget “1”. For example, reference to circulating fluid line 222 can include first circulating fluid line 222A and second circulating fluid line 222B, generically referred to as circulating fluid line or line(s) 222.

The number 222′ is utilized to refer to the fluid (e.g., water) circulating via circulating fluid line(s) 222 (e.g., first circulating fluid line 222A, second circulating fluid line 222B). Although sometimes referred to herein as “circulating water” rather than “circulating fluid” lines and streams, it is to be understood that the circulating fluid can comprise a fluid other than water.

Herein disclosed is a phosphate-free enhanced copolymer that can be more cost effective and environmentally friendly as a corrosion inhibitor (e.g., for mild steel) in circulating water systems relative to traditional phosphate-based inhibitors. In embodiments, the herein disclosed phosphate-free enhanced polymer corrosion inhibitor can significantly reduce, or eliminate, the need for polymeric dispersants for calcium phosphate scale control. Additionally, phosphate-free corrosion inhibitor of this disclosure does not form calcium phosphate scale, and allows for treatment of high stressed heat exchangers (e.g., heat exchangers operated at elevated temperatures, such as greater than or equal to about 130° F. (54.4° C.), 140° F. (60° C.), or 150° F. (65.6° C.)), in embodiments.

It has been unexpectedly discovered that a deposit (e.g., scale) control agent comprising an enhanced copolymer can be utilized as a corrosion inhibitor, optionally in combination with a metal ion, as described hereinbelow. In embodiments, when at sufficient concentration, the enhanced copolymer can be utilized as a corrosion inhibitor in the absence of the addition of metal ion(s).

A method of inhibiting corrosion of mild steel in aqueous industrial systems according to this disclosure can comprise: adding a corrosion inhibitor to the aqueous system, wherein the corrosion inhibitor comprises an enhanced copolymer, such as described hereinbelow, at a concentration of from about 1 to about 50 ppm. In embodiments, the corrosion inhibitor further comprises a salt selected from zinc salts, aluminum salts, manganese salts, molybdate salts, tin salts, other salts, or any combination thereof, for example at a concentration of from about 0.5 ppm to about 5 ppm.

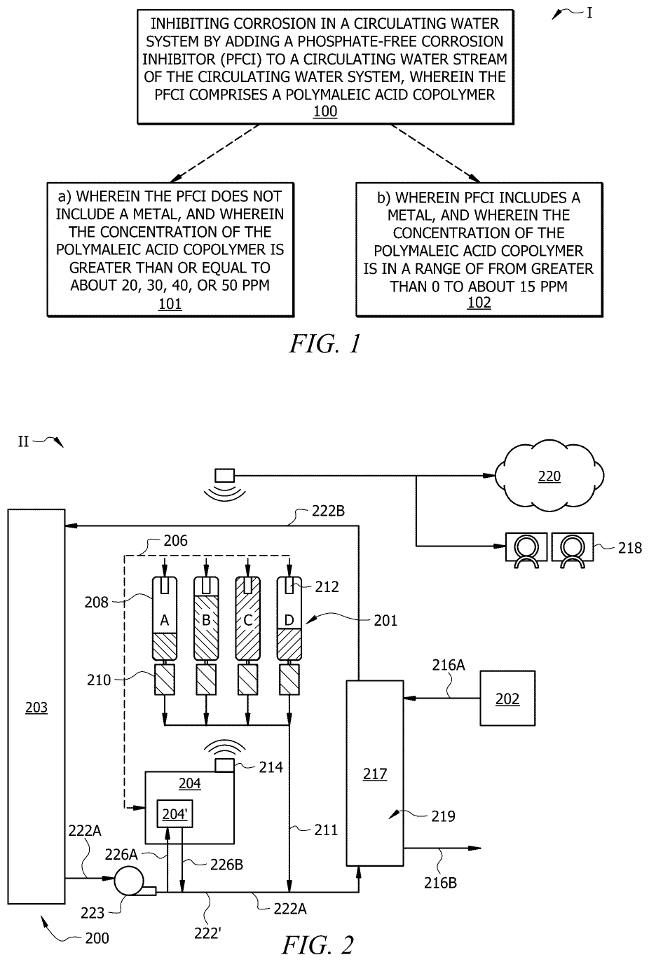

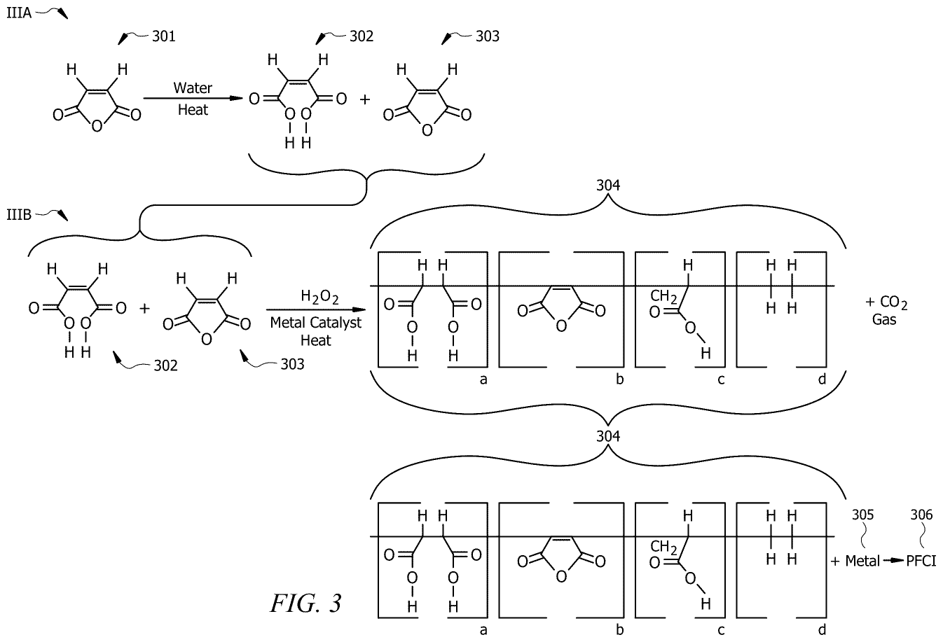

With reference to FIG. 1, which is a schematic of a method I according to embodiments of this disclosure, a method I can comprise, as depicted at 100: inhibiting corrosion in a circulating fluid (e.g., water) system (II, of FIG. 2, discussed hereinbelow) by: adding a corrosion inhibitor (306, FIG. 3) comprising, consisting essentially of, or consisting of a phosphate-free corrosion inhibitor (PFCI) and optionally a metal to a circulating fluid (e.g., water) 222′ in circulating fluid lines 222 (222A, 222B) in the circulating fluid system (II). The PFCI 306 comprises a polymaleic acid copolymer (304, of FIG. 3, described hereinbelow).

With reference to FIG. 2, which is a schematic of a representative system II, according to embodiments of this disclosure, a system II of this disclosure can comprise: a circulating water system 200 comprising: a heat exchanger 217; a cooling tower 203; circulating water lines 222 (e.g., 222A, 222B) configured to circulate a circulating water 222′, and comprising a first circulating water line 222A configured to circulate a portion of the circulating water 222′ comprising relatively cooler water from the cooling tower 203 to the heat exchanger 217 and a second circulating water line 222B configured to circulate another portion of the circulating water 222′ comprising relatively hotter water from the heat exchanger 217 to the cooling tower 203; and a dosing system 202 comprising one or more dosing apparatus 208 configured to add one or more components (e.g., component A, component B, component C, component D) to the circulating water 222′ via dosing line(s) 211. The dosing system 201 introduces one or more components of a phosphate free corrosion inhibitor (PFCI) 306 (FIG. 3) to the circulating water 222′. According to this disclosure, least one of the one or more dosing apparatus 208 contains (or provides component(s) for) a phosphate-free corrosion inhibitor (PFCI) 306 and is configured to add the PFCI (e.g., via one or more dosing lines 211) to the circulating water stream in circulating water lines 222. As described further hereinbelow with reference to FIG. 3, the corrosion inhibitor 306 can comprise, consists essentially of, or consists of a polymaleic acid copolymer 304 and optionally a metal 305. For example, one or more of dosing apparatus can contain the polymaleic acid copolymer 304, one or more of dosing apparatus can contain the metal 305, one or more of dosing apparatus can contain the PFCI 306 (which can consist of the polymaleic acid copolymer 304 and optionally the metal 305), or the components of the PFCI 306 can be introduced via separate dosing systems 201.

With reference to FIG. 2, the circulating water system 200 of a circulating water operation II (also referred to herein as an “industrial water operation” II or a simply a system II) can comprise a cooling tower 203; treatment chemical dosing reservoirs 208; which comprise four dosing reservoirs in the embodiment of FIG. 2, dosing reservoirs 208A, 208B, 208C, and 208D; associated metering pumps 210; and heat exchanger 217 having process fluid inlet and outlet 216A, 216B thereto. The process inlet 216A of heat exchanger 217 can be fluidly connected with process 202, from which the process fluid to be cooled is obtained. Circulating water system 200 can further include a chemical water treatment analysis unit 204 comprising a sensor 204′ (e.g., a MEMS sensor); fluid level control communications 206; a level sensor 212, which can comprise level sensors 212A, 212B, 212C, and 212D associated with dosing reservoirs 208A-208D, respectively; a communications link to cloud and control center 214; control room 218; and/or cloud 220.

The circulating fluid 222′ can be water and the circulating fluid system 200 can be a circulating water system 200. The circulating water system II can be selected from industrial water systems, boilers, cooling towers, evaporators, digestors, membranes, thermal desalination systems, recreational water systems, swimming pools, spas, hot tubs, decorative fountains, potable water systems, reverse osmosis membranes, filtration systems, top-side oil systems, down-hole oil systems, top-side gas systems, down-hole gas systems, squeeze treatments, flood treatments, drilling systems, fracturing applications, mining systems, pulp-and-paper systems, sugar evaporators, ethanol evaporators, household cleaning systems, laundry systems, textile processing systems, or combinations thereof.

Process 202 produces a process stream 216A. Process 202 may be any process which produces a hot process stream as a product, or any intermediate process which produces a hot stream. Some examples of process 202 may include, but are not limited to, reactors, distillation columns, heaters, or any other process. Process stream 216A may be introduced into heat exchanger 217 whereby a cooling fluid in circulating line 222, such as water, is brought in thermal contact with process stream 216A. Cooling fluid in circulating line 222 may be at a temperature lower than process stream 216A to facilitate heat exchange between cooling fluid in line 222 and process stream 216A. Process stream 216B may exit heat exchanger 217 at a relatively lower temperature than entry and cooling fluid 222′ may exit heat exchanger 217 via second circulating line 222B at a relatively higher temperature than entry via first circulating line 222A. Although only one heat exchanger 217 is shown, cooling fluid 222′ may be used in a plurality of heat exchangers 217 for different process streams 216A. Cooling fluid 222′ in lines 222 may be introduced to contaminants from process streams in the heat exchangers or during transport of cooling fluid between heat exchangers 217, for example. Some non-limiting examples of contaminants may include, for example, methane, ethane, ethylene, acetylene, propane, propylene, n-butane, iso-butane, and combinations thereof.

Cooling fluid 222′ in second circulating line 222B leaving heat exchanger 217 may be too hot to continue to be used to cool further process streams and may be conveyed to cooling tower 203. In cooling tower 203, evaporative cooling or forced convection cooling may remove heat from cooling fluid thereby generating a cooling fluid with a lowered temperature. The cooling fluid 222′ may exit cooling tower 203 and be conveyed back to heat exchanger 217. A slip stream 226A may be taken from cooling fluid 222′ in first circulating line 222A before the relatively cool cooling fluid 222′ (e.g., that is cool relative to the cooling fluid in second circulating fluid line 222B) is introduced into heat exchanger 217 and/or a slip stream 226A can be taken from relatively hotter cooling fluid 222′ (e.g., that is hotter relative to the cooling fluid in first circulating fluid line 222A) in second circulating line 222B before the cooling fluid is introduced into cooling tower 203. Slip stream 226A may be conveyed to detection unit 204 for analysis. Once analyzed, the contents of slip stream 226A may be returned to cooling fluid in circulating line 222 (e.g., first circulating line 222A and/or second circulating line 222B) via return line 226B. Although slip stream 226A is illustrated as being drawn from cooling fluid in first circulating line 222A between cooling tower 203 exit and heat exchanger 217 entrance and, slip stream may be taken at any point. For example, as noted above, in embodiments, slip stream 226A can be drawn from cooling fluid 222′ in second circulating line 222B after exiting heat exchanger 217 and before entering cooling tower 203. In embodiments where cooling fluid 222′ is conveyed to a plurality of heat exchangers 217, a sample may be drawn via slipstream 226A before and/or after any heat exchanger 217 in the plurality of heat exchangers 217. There may be a heat exchanger 217 fluidically coupled to a process 202 which may be prone to introducing contaminants into cooling fluids 222′ and thus may require more closely monitored sampling.

As depicted in FIG. 2, heat exchanger 217 exit line 222B (also referred to as “second circulating fluid line 222B”) is introduced to cooling tower 202, whereas cooling tower exit line/outlet 222A (also referred to herein as “first circulating fluid line 222A”) can be pumped via pump 223 into heat exchanger 217. One or more pumps 223 can be located elsewhere in system II, in embodiments. Within heat exchanger 217, heat can be exchanged between the relatively hot process fluid 216A (hot relative to the relatively cold process fluid 216B) and the relatively cold circulating heat exchange fluid 222′ in first circulating line 222A (relatively cold relative to the relatively hot circulating heat exchange fluid 222′ in second circulating line 222B). As noted above, the circulating fluid 222′ in first circulating line 222A and/or second circulating line 222B can connect to chemical water treatment analysis unit 204 through inlet line 226A and outlet line 226B. Chemical water treatment analysis unit 204 can comprise a sensor device 204′ (e.g., a microelectromechanical system (MEMS) sensor). A plurality of parameters may be detected and analyzed by chemical treatment analysis unit 204. For example, corrosion by-products may be detected and the chemical treatment concentration in circulating fluid stream 222′ may be analyzed. Circulating fluid 222′ in circulating lines 222 may enter (e.g., MEMS-based) chemical water treatment analysis unit 204 via inlet 226A and contact (e.g., at least a portion of an array of MEMS sensors of) sensor 204′, in embodiments. Circulating fluid 222′ can exit chemical water treatment analysis unit 204 via exit line 226B, optionally emptying into first circulating line 222A downstream of pump 223. Circulating fluid 222′ may be analyzed for specific components, as the slip stream fluid contacts sensor 204′. The data generated by sensor 204′ may be transmitted to cloud 220, where the data may be saved and downloaded to control room 218, wherein an analysis may be performed for the purpose of determining the proper dosing requirements (e.g., amounts of PFCI 306 to be added) for chemical treatment. Sensor 204′ can comprise a MEMS device as described in U.S. Pat. No. 11,360,014 and/or a hydrogen sensor as described in U.S. Patent App. No. 2020/0049434, the disclosures of each of which are hereby incorporated herein for purposes not contrary to this disclosure.

In addition to the determination of the proper dosing requirements for chemical treatment, the industrial water operation II may be continually monitored, controlled, and adjusted by the control room 218 based on cloud 220 communication between the chemical water treatment analysis unit 204 and the control room 218. The analysis, monitoring, controlling and adjusted may be accomplished in real-time. Consequently, chemical treatment dosing reservoirs 208A, 208B, 208C, 208D may be controlled by control room 218 via cloud communication link 214 or it may be manually controlled at the source. Metering pumps 210 may dispense the specific amount of dosing of each of chemical treatment reservoirs 208A, 208B, 208C, 208D into (e.g., first) circulating line 222 (e.g., 222A downstream of pump 223). After heat exchange in heat exchanger 217, the treated water may then be circulated via second circulating stream 222B to cooling tower 203.

Description of the copolymer 304 of a PFCI 306 according to embodiments of this disclosure will now be made with reference to FIG. 3, which is a schematic of chemical structures and reactions related to an enhanced copolymer 304 according to embodiments of this disclosure. In embodiments, an enhanced copolymer 304 of this disclosure can prepared in-situ as a substantially maleic acid copolymer by polymerizing maleic acid monomer components. As schematically depicted at the top of FIG. 3, a pre-polymerization step IIIA can include hydrolysis (e.g., in the presence of water and heat) of maleic anhydride 301 to form maleic acid monomer 302 and unreacted maleic anhydride 303. The maleic acid monomer components can be transformed into monomeric repeating units within each polymer molecule. As schematically represented at the bottom of FIG. 3, polymerization with in-situ decarboxylation IIIB can be effected in the presence of hydrogen peroxide (H₂O₂), a metal catalyst, and heat. The metal catalyst can comprise, for example, zinc, aluminum, tin (e.g., tin (II)), manganese, molybdenum (e.g., molybdate), or a combination thereof.

In embodiments, the polymerization IIIB is an aqueous polymerization, which may provide various advantages such as being more economical than alternate methods of polymerization, yielding a polymer 304 with lower aquatic toxicity, etc. An additional and previously under-appreciated advantage of aqueous polymerization can be that it can provide a superior environment for beneficial in-situ copolymerization, such as producing improved copolymers 304 exhibiting, for example, superior crystal habit modification properties and enhanced corrosion inhibiting properties. Contrary to common practice and understanding, rather than attempting to minimize decarboxylation during the polymerization process, there can be an effort to increase decarboxylation. This may be achieved, for example, by changing various process parameters such as reaction temperature, a concentration of metal catalyst used, a concentration of hydrogen peroxide used, and/or adjusting other reaction additives. A result of increased decarboxylation during polymerization IIIB can be that, during the polymerization process, some of the maleic acid monomer components become non-carboxylated monomeric repeating units of the polymer being formed, resulting in an in-situ created copolymer 304 rather than a substantially pure homopolymer. In embodiments, the process also gives rise to terminal hydroxyl groups in the copolymer 304.

The copolymer 304 can include a quantity of non-functionalized groups which may, in application, aid in the corrosion inhibiting properties thereof and/or the adsorption of the copolymer 304 onto a metal surface. An enhanced polymaleic acid copolymer 304 prepared in such a manner may preferably include mono-carboxylic acids, non-ionic functional groups, and terminal hydroxyl groups in proportions to achieve the desired treatment functionalities. For example, such a copolymer 304 may include at least approximately 10% (Mw) polymaleic acid and at least approximately 10% (Mw) of in-situ formed co-monomers, including at least 10% (Mw) decarboxylated maleic acid.

The enhanced copolymer 304 can a significantly higher proportion of decarboxylated monomeric repeating units than prior art materials. In embodiments, as depicted by way of example in FIG. 3, the enhanced copolymer, with molecular weight of the combined copolymer 304 between 300 and 3,000 Daltons, copolymer constituent proportions can include: maleic acid [a] can be present at over 50 mole percent, maleic anhydride [b] can be present at up to 5 mole percent, acrylic acid [c] can be present at up to 50 mole percent, and/or a 2-carbon alkane group [d] can be present at up to 50 mole percent.

In embodiments, the polymaleic acid copolymer 304 comprises at least 5 mole percent decarboxylated maleic acid repeating units. In embodiments, the polymaleic acid copolymer 304 comprises: mono-carboxylic acids, terminal hydroxyl groups, and non-ionic functional groups (e.g., which aid in inhibiting corrosion and/or which aid in adsorption onto a metal surface). The non-ionic functional groups and the terminal hydroxyl groups can be formed during the aqueous polymerization process IIIB, so that said maleic acid copolymer 304 comprises at least approximately 50 mole percent maleic acid and up to 50 mole percent free radical polymerized co-monomers.

A copolymer 304 prepared in accordance with the principles disclosed herein, or characterized by the attributes disclosed herein, as a further embodiment of the invention can be applied to an aqueous system (e.g., system II) as a treatment additive to inhibit corrosion.

The method can comprise adding the PFCI 306 to a concentration of from about 1 to about 100 ppm, from about 5 to about 100 ppm, from about 10 to about 100 ppm, from about 10 to about 80 ppm, from about 10 to about 75 ppm, or from about 10 to about 50 ppm in the circulating water 222′ (e.g., in first circulating fluid stream 222A, second circulating fluid stream 222B, or both).

As depicted at 101 of FIG. 1, method I can comprise embodiments (a) in which the PFCI 306 does not include a metal 305. In embodiments in which the PFCI does not comprise the metal 305 (i.e., a metal 305 is not added to the circulating fluid in circulating fluid lines 222 separately or in combination with the polymaleic acid copolymer 304), the PFCI (e.g., the polymaleic acid copolymer 304) can be added to the circulating water stream 222′ in circulating fluid line(s) 222 to a concentration of from about 10 to about 100, from about 20 to about 100 ppm, from about 30 to about 100 ppm, or from about 30 to about 40 ppm.

As depicted at 102 of FIG. 1, method I can comprise embodiments (b) in which the PFCI 306 comprises the metal 305 (e.g., a metal 305 is added in addition to the copolymer 304). The metal 305 can be selected from zinc, aluminum, tin, manganese, molybdenum, or a combination thereof. The metal 305 can be provided by a metal salt. The metal salt can comprise a zinc salt, an aluminum salt, a tin salt, a manganese salt, a molybdenum salt, or a combination thereof. In embodiments comprising the metal 305, the polymaleic acid copolymer 304 can be added to the circulating water 222′ at a concentration of from greater than zero to about 15 ppm, from greater than 0 to about 10 ppm, or from about 0.001, 0.1, 0.2, 0.3, 0.4, 0.5, 0.6, 0.7, 0.8, 0.9, 1, 2, 3, 4, or 5 to about 10, 11, 12, 13, 14, or 15 ppm. In embodiments, no other corrosion inhibitor is added to the circulating water 222′ other than the PFCI 306.

In embodiments, corrosion is inhibited by the use of the herein disclosed PFCI 306, without the need for dispersants, such as polymeric dispersants for general dispersion, such as anion/cation pairs stabilization in circulating water.

A corrosion rate of a metal component 219 (e.g., a circulating fluid contact surface 219 of heat exchanger 217) of the circulating water system 200 in contact with the circulating water 222′ in circulating line(s) 222 can be less than or equal to about 2 mils per year (mpy). In embodiments, the corrosion rate of the metal component 219 of the circulating water system 200 in contact with the circulating fluid 222′ (e.g., circulating water) is less than or equal to about 1 mil per year (mpy). The metal component 219 of the system II in contact with the circulating water stream (i.e., the circulating fluid 222′ in circulating fluid system 200) can comprises mild steel (e.g., carbon steel). As noted above, the metal component 219 of the circulating water system 200 in contact with the circulating water stream can be a component of a heat exchanger 217, a flow line (e.g., lines 222, 226A, 226B), a pump 223, an analysis unit 204, a cooling tower 203, or a combination thereof. In embodiments, the metal component 219 is a contact component of a heat exchanger 217, for example, a high stress heat exchanger 217 defined by operation at a temperature of greater than or equal to about 130° F. (54.4° C.), 140° F. (60° C.), or 150° F. (65.6° C.).

In embodiments, a corrosion rate of less than or equal to about 2, 1, or 0.5 mils/year is obtained under conditions including a temperature of greater than or equal to about 130° F. (54.4° C.), 140° F. (60° C.), or 150° F. (65.6° C.), a pH of the circulating water stream 222′ of greater than or equal to about 7.5, 8.0, or 8.5, a total amount of calcium and magnesium ions (Ca⁺²+Mg⁺²) in the circulating water stream that is greater than or equal to about 600 ppm, a total amount of chloride and sulfate ions (Cl⁻¹+SO₄⁻²) in the circulating water stream that is greater than or equal to about 600 ppm, or a combination thereof.

In embodiments, the PFCI 306 does not promote and/or actively inhibits the formation of calcium phosphate scale. In embodiments, the PFCI does not contain and/or the method does not comprise adding benzotriazole (BTA) (e.g., the PFCI or corrosion inhibitor added comprises less than or equal to about 5, 4, 3, 2, 1, 0.1, 0.01, 0.001, or 0.0 wt. % BTA).

In embodiments, a method of this disclosure comprises inhibiting corrosion in a circulating water system II by: adding a phosphate-free corrosion inhibitor (PFCI) 306 to a circulating water stream 222′ in the circulating water system II, wherein the PFCI 306 comprises a polymaleic acid copolymer 304 and: (a) wherein the PFCI 306 does not include a metal 304 (i.e., a metal 305 is not added separately or as a component of the PFCI 306), and a concentration of the copolymer 304 in the circulating water stream 222′ is in a range of from about 20 to about 50 ppm, from about 30 to about 50 ppm, or from about 30 to about 50 ppm; or (b) wherein the PFCI 306 further comprises a metal 305 (i.e., a metal 305 is added separately or as a component of the PFCI 306), and the concentration of the copolymer 304 in the circulating water stream 222′ is in a range of greater than zero to about 15, 14, 13, 12, 11, 10, 9, 8, 7, 6, 5, 4, 3, 2, or 1 ppm. In embodiments comprising (b), as noted above, the metal 305 can comprise zinc (Zn), aluminum (Al), manganese (Mn), molybdenum (Mo), tin (Sn), or a combination thereof. As detailed previously, a corrosion rate of a metal component 219 of the circulating water system II in contact with the circulating water stream can be less than or equal to about 2 or 1 mils per year (mpy). The metal component 219 of the circulating water system II in contact with the circulating water stream can comprise mild steel (e.g., carbon steel).

In embodiments, the one or more components include metal 305, and at least one of the one or more dosing apparatus 208 containing the PFCI 306 is configured to add the PFCI 306 to the circulating water stream 222 such that the circulating water stream 222 has a PFCI concentration in a range of from greater than zero to about 15, 14, 13, 12, 11, 10, 9, 8, 7, 6, 5, 4, 3, 2, or 1 ppm. The dosing system 201 can be configured to add the metal 305 to the circulating water stream such that the circulating water stream has a metal concentration in a range of from greater than zero to about 5 ppm, from about 0.1 to about 5 ppm, or from about 0.5 to about 5 ppm.

In embodiments wherein the one or more components (e.g., A, B, C, D of FIG. 2) do not include a metal 305, the at least one of the one or more dosing apparatus containing the PFCI can be configured to add the PFCI (e.g., the copolymer 304) to the circulating water stream such that the circulating water stream has a PFCI 306 or copolymer 304 concentration in a range of from about 20 to about 50 ppm, from about 30 to about 50 ppm, or from about 30 to about 50 ppm. The corrosion inhibitor 306 added to the circulating fluid stream in circulating fluid lines 222 can consist essentially of the PFCI 306 (e.g., which can consist essentially of the copolymer 304) and optionally the metal 305.

Dosing system 201 can be configured to add the PFCI 306 (e.g., the copolymer 304 and/or the optional metal 305) as a solid. Alternatively or in combination, the dosing system 201 can be configured to add the PFCI (e.g., the copolymer and the optionally the metal) as an aqueous solution.

Key benefits of the herein disclosed phosphate-free corrosion inhibitors as compared to traditional phosphate-based chemistry can include, but are not limited to: providing for a lower cost cooling water treatment program; enabling operation in high stress heat exchanger applications; eliminating calcium phosphate scale formation; reducing phosphate discharge to the environment; and/or immunity to global phosphate price volatility.

Phosphate-free corrosion inhibitors allow for the treatment of high stress heat exchangers without calcium phosphate scale formation. Additionally, the herein disclosed phosphate-free corrosion inhibitor chemistry can be utilized, in embodiments, without metal ions (such as, and without limitation, Zn, Al, Sn, and/or Mo) in the phosphate-free corrosion inhibitor formulation.

Many modifications or expansions upon the invention and the various illustrative embodiments described in this application still fall within the spirit and scope of the invention, and should be so considered.

### Example

The embodiments having been generally described, the following Example is given as particular embodiments of the disclosure and to demonstrate the practice and advantages thereof. It is understood that the examples are given by way of illustration and are not intended to limit the specification or the claims in any manner.

Corrosion experiments were performed using Gamry Linear Polarization Resistance (LPR) three electrode setup. LPR is an electrochemical technique that measures the current required to achieve small, stepwise changes in the working electrode's free corroding potential (Ecorr). The change in the electrode's potential over a specified range divided by the change in current density (ΔE/Δi) is used to calculate the electrode's polarization resistance (Rp). The polarization resistance value is then used to calculate the corrosion current, and subsequently the corrosion rate, as described in ASTM G59 and G102. Mild steel C1018 P/N: EL4103772800000; Ref: Metal Samples Company (alspi.com) was used as a working electrode together with stainless-steel auxiliary and pseudo reference electrode. Corrosion measurements were recorded over 24 hours and the flat curve corrosion rate was used as a final corrosion rate.

Mild Steel Corrosion Test Results are provided in Table 1 for the blank/untreated coupon, Samples 1 to 8 comprising enhanced polymer PFCI 306 (INITIA® 585) and zinc, and Samples 9-12 comprising enhanced polymer and no zinc.

TABLE 1
Results from the Example

| | INITIA ® | | | | Ca + Mg | Cl + SO₄ | Corrosion |
|---|---|---|---|---|---|---|---|
| | 585 | Zinc | | Temperature | 50/50 | 50/50 | Rate |
| Test ID | (ppm) | (ppm) | pH | (° F.) | (ppm) | (ppm) | (mpy*) |
| Blank | 0 | 0 | 7.5 | 140 | 600 | 600 | 39.7 |
| 1 | 6.5 | 0.5 | 7.5 | 140 | 600 | 600 | 0.48 |
| 2 | 6.5 | 0.5 | 8.5 | 140 | 600 | 600 | 0.93 |
| 3 | 6.5 | 1 | 7.5 | 140 | 600 | 600 | 0.33 |
| 4 | 6.5 | 3 | 7.5 | 140 | 600 | 600 | 0.43 |
| 5 | 13 | 0.5 | 7.5 | 140 | 600 | 600 | 1.2 |
| 6 | 13 | 0.5 | 8.5 | 140 | 600 | 600 | 0.5 |
| 7 | 13 | 1 | 7.5 | 140 | 600 | 600 | 0.66 |
| 8 | 13 | 3 | 7.5 | 140 | 600 | 600 | 0.49 |
| 9 | 20 | 0 | 7.5 | 140 | 600 | 600 | 1.8 |
| 10 | 20 | 0 | 8.5 | 140 | 600 | 600 | 1.7 |
| 11 | 40 | 0 | 7.5 | 140 | 600 | 600 | 0.31 |
| 12 | 40 | 0 | 8.5 | 140 | 600 | 600 | 0.80 |

*mils per year

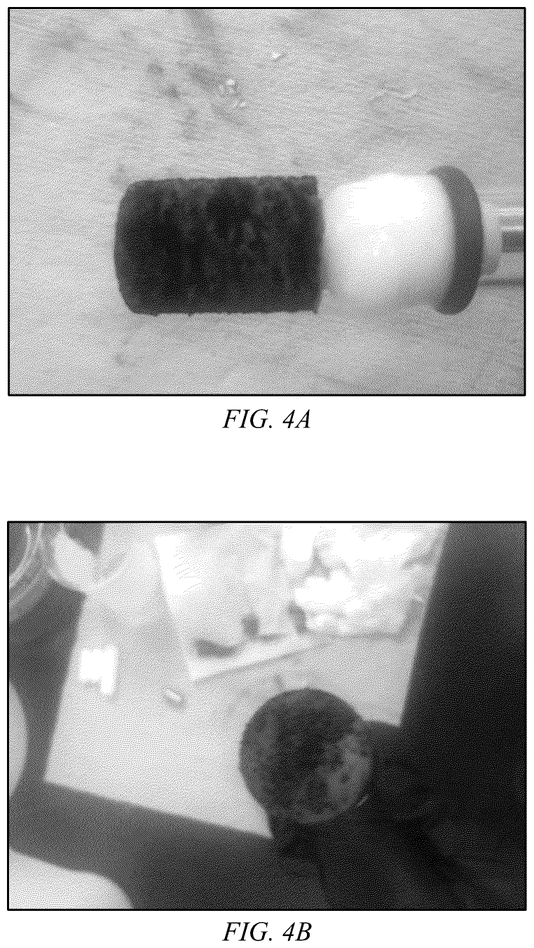

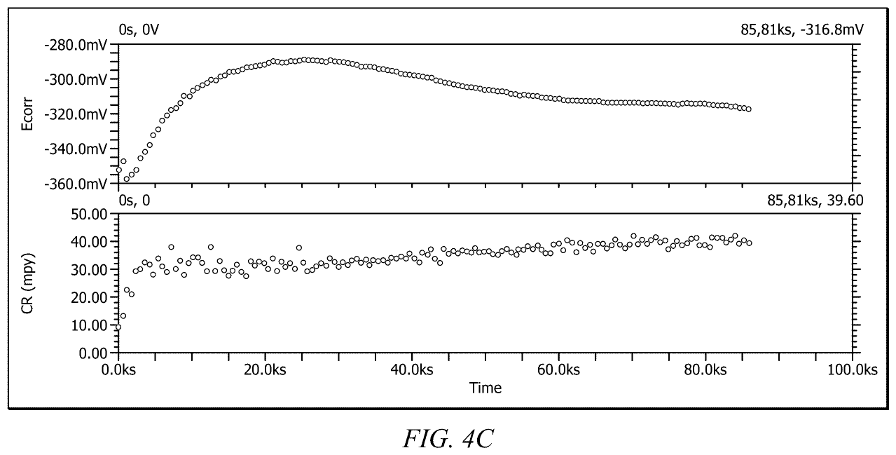

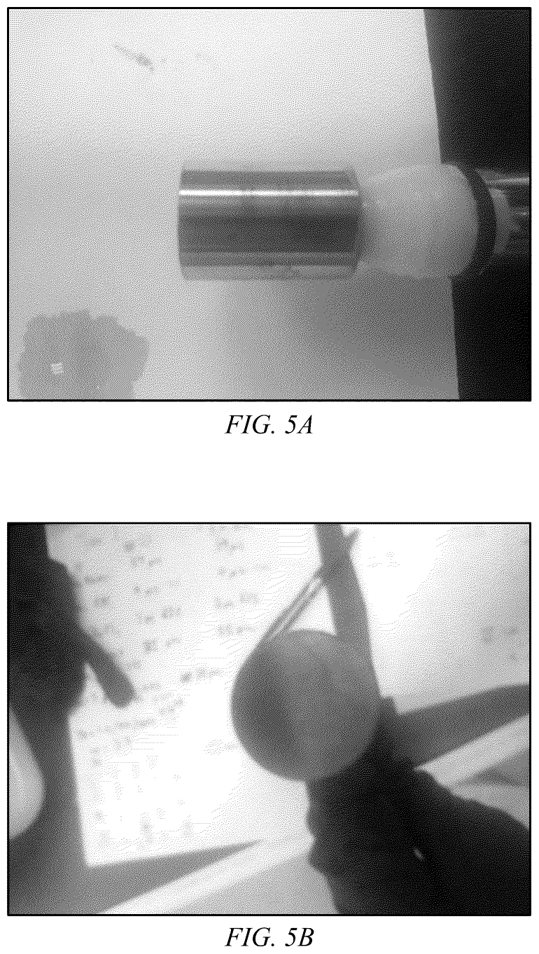

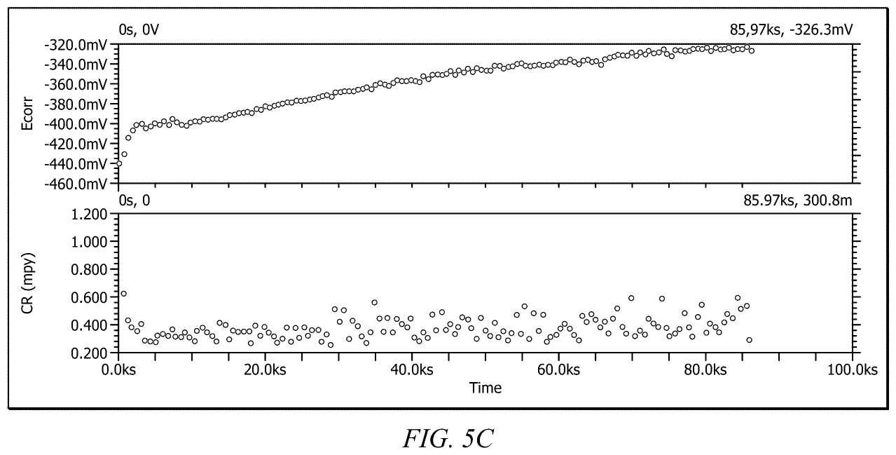

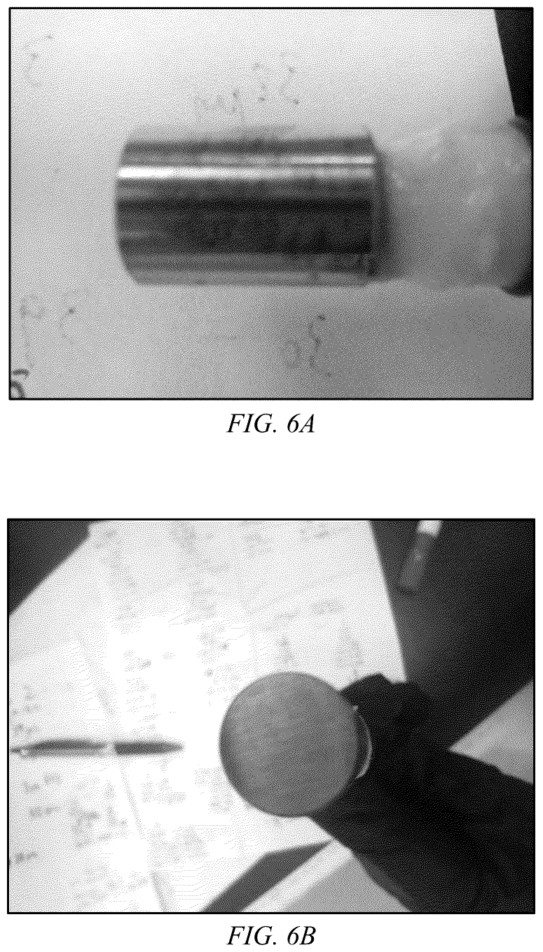

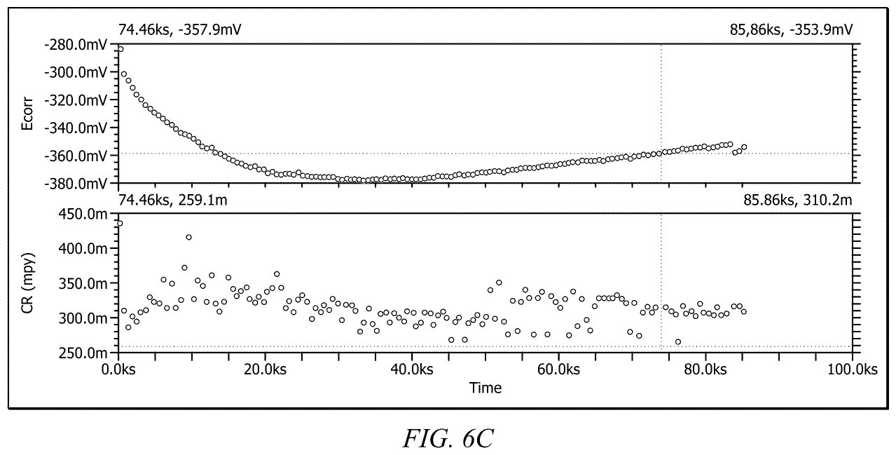

FIG. 4A and FIG. 4B are side view and top view pictures of the untreated coupon, showing general corrosion, pitting corrosion and corrosion byproducts. FIG. 4C is a LPR corrosion rate curve for the untreated coupon showing corrosion at 40 mpy. FIG. 5A and FIG. 5B are side view and top view pictures of coupon test ID #3, showing minimal corrosion. No pitting corrosion or corrosion byproducts were observed on the coupon. FIG. 5C is a LPR corrosion rate curve for this coupon test ID #3 showing corrosion at 0.33 mpy. FIG. 6A and FIG. 6B are side view and top view pictures of coupon test ID #11, showing minimal corrosion. FIG. 6C is a LPR corrosion rate curve for this coupon test ID #11 showing corrosion at 0.31 mpy.

### Additional Disclosure

The following are non-limiting, specific embodiments in accordance with the present disclosure:

In a first embodiment, a method comprises: inhibiting corrosion in a circulating water system by: adding a corrosion inhibitor consisting essentially of a phosphate-free corrosion inhibitor (PFCI) comprising a polymaleic acid copolymer and optionally a metal to a circulating water stream in the circulating water system.

A second embodiment can include the method of the first embodiment, comprising adding the PFCI to a concentration of from about 1 to about 100 ppm, from about 5 to about 100 ppm, or from about 10 to about 100 ppm, from about 1 to about 75 ppm, from about 5 to about 75 ppm, or from about 10 to about 50 ppm in the circulating water stream.

A third embodiment can include the method of the first or second embodiment, wherein the PFCI comprises the metal.

A fourth embodiment can include the method of the third embodiment, wherein the metal is selected from zinc, aluminum, tin, manganese, molybdenum, or a combination thereof.

A fifth embodiment can include the method of the third or fourth embodiment, wherein the metal is provided by a metal salt.

A sixth embodiment can include the method of the fifth embodiment, wherein the metal salt comprises a zinc salt, an aluminum salt, a tin salt, a manganese salt, a molybdenum salt, or a combination thereof.

A seventh embodiment can include the method of any one of the third to sixth embodiments, wherein the polymaleic acid copolymer is added to the circulating water stream at a concentration of from greater than zero to about 15 ppm, from greater than 0 to about 10 ppm, or from about 0.001, 0.1, 0.2, 0.3, 0.4, 0.5, 0.6, 0.7, 0.8, 0.9, 1, 2, 3, 4, or 5 to about 10, 11, 12, 13, 14, or 15 ppm.

An eighth embodiment can include the method of any one of the first to seventh embodiments, wherein the PFCI does not comprise the metal.

A ninth embodiment can include the method of the eighth embodiment, wherein the PFCI is added to the circulating water stream to a concentration of from about 20 to about 100 ppm, from about 30 to about 100 ppm, or from about 30 to about 40 ppm.

A tenth embodiment can include the method of any one of the first to ninth embodiments, wherein a corrosion rate of a metal component of the circulating water system in contact with the circulating water stream is less than or equal to about 2 mils per year (mpy).

An eleventh embodiment can include the method of the tenth embodiment, wherein the corrosion rate of the metal component of the circulating water system in contact with the circulating water stream is less than or equal to about 1 mil per year (mpy).

A twelfth embodiment can include the method of the tenth or the eleventh embodiment, wherein the metal component of the circulating water system in contact with the circulating water stream comprises mild steel (e.g., carbon steel).

A thirteenth embodiment can include the method of any one of the tenth to twelfth embodiments, wherein the metal component of the circulating water system in contact with the circulating water stream is a component of a heat exchanger.

A fourteenth embodiment can include the method of the thirteenth embodiment, wherein the heat exchanger is a high stress heat exchanger as defined by operation at a temperature of greater than or equal to about 140° F. (60° C.).

A fifteenth embodiment can include the method of any one of the tenth to fourteenth embodiments, wherein the corrosion rate is obtained under conditions including a temperature of greater than or equal to about 140° F. (60° C.), a pH of the circulating water stream of greater than or equal to about 7.5, 8.0, or 8.5, a total amount of calcium and magnesium ions (Ca⁺²+Mg⁺²) in the circulating water stream that is greater than or equal to about 600 ppm, a total amount of chloride and sulfate ions (Cl⁻¹+SO₄⁺²) in the circulating water stream that is greater than or equal to about 600 ppm, or a combination thereof.

A sixteenth embodiment can include the method of any one of the first to fifteenth embodiments, wherein the PFCI does not promote the formation of calcium phosphate scale.

A seventeenth embodiment can include the method of any one of the first to sixteenth embodiments, wherein the polymaleic acid copolymer comprises at least 5 mole percent decarboxylated maleic acid repeating units.

An eighteenth embodiment can include the method of any one of the first to seventeenth embodiments, wherein the circulating water system is selected from the group consisting of industrial water systems, boilers, cooling towers, evaporators, digestors, membranes, thermal desalination systems, recreational water systems, swimming pools, spas, hot tubs, decorative fountains, potable water systems, reverse osmosis membranes, filtration systems, top-side oil systems, down-hole oil systems, top-side gas systems, down-hole gas systems, squeeze treatments, flood treatments, drilling systems, fracturing applications, mining systems, pulp-and-paper systems, sugar evaporators, ethanol evaporators, household cleaning systems, laundry systems, and textile processing systems.

A nineteenth embodiment can include the method of any one of the first to eighteenth embodiments, wherein the polymaleic acid copolymer comprises: mono-carboxylic acids, terminal hydroxyl groups, and non-ionic functional groups which aid in adsorption onto a metal (e.g., crystal) surface, wherein said non-ionic functional groups and said terminal hydroxyl groups are formed during an aqueous polymerization process, so that said maleic acid copolymer comprises at least approximately 50 mole percent maleic acid and up to 50 mole percent free radical polymerized co-monomers.

In a twentieth embodiment, a method comprises: inhibiting corrosion in a circulating water system by: adding a phosphate-free corrosion inhibitor (PFCI) to a circulating water stream in the circulating water system, wherein the PFCI comprises a polymaleic acid copolymer and: (a) wherein the PFCI does not include a metal, and wherein the concentration of the copolymer in the circulating water stream is in a range of from about 20 to about 100 ppm, from about 30 to about 100 ppm, or from about 30 to about 50 ppm; or (b) wherein the PFCI further comprises a metal, and wherein the concentration of the PFCI in the circulating water stream is in a range of greater than zero to about 15, 14, 13, 12, 11, 10, 9, 8, 7, 6, 5, 4, 3, 2, or 1 ppm.

A twenty first embodiment can include the method of the twentieth embodiment comprising (b), wherein the metal comprises zinc (Zn), aluminum (Al), manganese (Mn), molybdenum (Mo), tin (e.g., Sn (II)), or a combination thereof.

A twenty second embodiment can include the method of the twentieth or twenty first embodiments, wherein a corrosion rate of a metal component of the circulating water system in contact with the circulating water stream is less than or equal to about 2 or 1 mils per year (mpy).

A twenty third embodiment can include the method of the twenty second embodiment, wherein the metal component of the circulating water system in contact with the circulating water stream comprises mild steel (e.g., carbon steel).

A twenty fourth embodiment can include the method of any one of the twentieth to twenty third embodiments, wherein the polymaleic acid copolymer comprises at least 5 mole percent decarboxylated maleic acid repeating units.

A twenty fifth embodiment can include the method of any one of the twentieth to twenty fourth embodiments, wherein the circulating water system is selected from the group consisting of industrial water systems, boilers, cooling towers, evaporators, digestors, membranes, thermal desalination systems, recreational water systems, swimming pools, spas, hot tubs, decorative fountains, potable water systems, reverse osmosis membranes, filtration systems, top-side oil systems, down-hole oil systems, top-side gas systems, down-hole gas systems, squeeze treatments, flood treatments, drilling systems, fracturing applications, mining systems, pulp-and-paper systems, sugar evaporators, ethanol evaporators, household cleaning systems, laundry systems, and textile processing systems.

A twenty sixth embodiment can include the method of any one of the twentieth to twenty fifth embodiments, wherein the polymaleic acid copolymer comprises: mono-carboxylic acids, terminal hydroxyl groups, and non-ionic functional groups which aid in adsorption onto a metal surface, wherein said non-ionic functional groups and said terminal hydroxyl groups are formed during an aqueous polymerization process, so that said maleic acid copolymer comprises at least approximately 50 mole percent maleic acid and up to 50 mole percent free radical polymerized co-monomers.

In a twenty seventh embodiment, a system comprises: a circulating water system comprising: a heat exchanger; a cooling tower; water lines configured to circulate a circulating water stream, and comprising a first circulating water line configured to circulate a portion of the circulating water stream comprising relatively cooler water from the cooling tower to the heat exchanger and a second circulating water line configured to circulate another portion of the circulating water stream comprising relatively hotter water from the heat exchanger to the cooling tower; and a dosing system comprising one or more dosing apparatus configured to add one or more components of a corrosion inhibitor to the circulating water stream, wherein at least one of the one or more dosing apparatus contains a phosphate-free corrosion inhibitor (PFCI) and is configured to add the PFCI to the circulating water stream, wherein the corrosion inhibitor comprises a polymaleic acid copolymer and optionally a metal.

A twenty eighth embodiment can include the system of the twenty seventh embodiment, wherein the one or more components include a metal, and wherein the at least one of the one or more dosing apparatus containing the PFCI is configured to add the PFCI to the circulating water stream such that the circulating water stream has a PFCI concentration in a range of from greater than zero to about 15, 14, 13, 12, 11, 10, 9, 8, 7, 6, 5, 4, 3, 2, or 1 ppm.

A twenty ninth embodiment can include the system of the twenty eighth embodiment, wherein the dosing system is configured to add the metal to the circulating water stream such that the circulating water stream has a metal concentration in a range of from greater than zero to about 5 ppm, from about 0.1 to about 5 ppm, or from about 0.5 to about 5 ppm.

A thirtieth embodiment can include the system of any one of the twenty seventh to twenty ninth embodiments, wherein the one or more components do not include a metal, and wherein the at least one of the one or more dosing apparatus containing the PFCI is configured to add the PFCI to the circulating water stream such that the circulating water stream has a PFCI concentration in a range of from about 20 to about 100 ppm, from about 30 to about 100 ppm, or from about 30 to about 50 ppm.

A thirty first embodiment can include the system of any one of the twenty seventh to thirtieth embodiments, wherein the corrosion inhibitor consists essentially of the PFCI and optionally the metal.

A thirty second embodiment can include the system of any one of the twenty seventh to thirty first embodiments, wherein the dosing system is configured to add the PFCI and the optionally the metal as a solid.

A thirty third embodiment can include the system of any one of the twenty seventh to thirty second embodiments, wherein the dosing system is configured to add the PFCI and the optionally the metal as an aqueous solution.

A thirty fourth embodiment can include the system of any one of the twenty seventh to thirty third embodiments, wherein the polymaleic acid copolymer comprises at least 5 mole percent decarboxylated maleic acid repeating units.

A thirty fifth embodiment can include the system of any one of the twenty seventh to thirty fourth embodiments, wherein the circulating water system is selected from the group consisting of industrial water systems, boilers, cooling towers, evaporators, digestors, membranes, thermal desalination systems, recreational water systems, swimming pools, spas, hot tubs, decorative fountains, potable water systems, reverse osmosis membranes, filtration systems, top-side oil systems, down-hole oil systems, top-side gas systems, down-hole gas systems, squeeze treatments, flood treatments, drilling systems, fracturing applications, mining systems, pulp-and-paper systems, sugar evaporators, ethanol evaporators, household cleaning systems, laundry systems, and textile processing systems.

A thirty sixth embodiment can include the system of any one of the twenty seventh to thirty fifth embodiments, wherein the polymaleic acid copolymer comprises: mono-carboxylic acids, terminal hydroxyl groups, and non-ionic functional groups which aid in adsorption onto a metal surface, wherein said non-ionic functional groups and said terminal hydroxyl groups are formed during an aqueous polymerization process, and wherein the maleic acid copolymer comprises at least approximately 50 mole percent maleic acid and up to 50 mole percent free radical polymerized co-monomers.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
inhibiting corrosion in a circulating water system by: adding a corrosion inhibitor consisting essentially of a phosphate-free corrosion inhibitor (PFCI) comprising a polymaleic acid copolymer and optionally a metal to a circulating water stream in the circulating water system.

2. The method of claim 1 comprising adding the PFCI to a concentration of from about 1 to about 100 ppm in the circulating water stream.

3. The method of claim 1, wherein the PFCI comprises the metal.

4. The method of claim 3, wherein the polymaleic acid copolymer is added to the circulating water stream at a concentration of from greater than zero to about 15 ppm.

5. The method of claim 1, wherein the PFCI does not comprise the metal.

6. The method of claim 5, wherein the PFCI is added to the circulating water stream to a concentration of from about 20 to about 100 ppm.

7. The method of claim 1, wherein the polymaleic acid copolymer comprises at least 5 mole percent decarboxylated maleic acid repeating units.

8. The method according to claim 1, wherein the polymaleic acid copolymer comprises:
mono-carboxylic acids,
terminal hydroxyl groups, and
non-ionic functional groups which aid in adsorption onto a metal surface,
wherein said non-ionic functional groups and said terminal hydroxyl groups are formed during an aqueous polymerization process, so that said maleic acid copolymer comprises at least approximately 50 mole percent maleic acid and up to 50 mole percent free radical polymerized co-monomers.

9. A method comprising:
inhibiting corrosion in a circulating water system by:
adding a phosphate-free corrosion inhibitor (PFCI) to a circulating water stream in the circulating water system,
wherein the PFCI comprises a polymaleic acid copolymer and:
(a) wherein the PFCI does not include a metal, and wherein the concentration of the copolymer in the circulating water stream is in a range of from about 20 to about 100 ppm; or
(b) wherein the PFCI further comprises a metal, and wherein the concentration of the PFCI in the circulating water stream is in a range of greater than zero to about 15 ppm.

10. The method of claim 9 comprising (b), wherein the metal comprises zinc (Zn), aluminum (Al), manganese (Mn), molybdenum (Mo), tin (Sn), or a combination thereof.

11. The method of claim 9, wherein a corrosion rate of a metal component of the circulating water system in contact with the circulating water stream is less than or equal to about 2 mils per year (mpy).

12. The method of claim 9, wherein the polymaleic acid copolymer comprises at least 5 mole percent decarboxylated maleic acid repeating units.

13. The method according to claim 9, wherein the polymaleic acid copolymer comprises:
mono-carboxylic acids,
terminal hydroxyl groups, and
non-ionic functional groups which aid in adsorption onto a metal surface,
wherein said non-ionic functional groups and said terminal hydroxyl groups are formed during an aqueous polymerization process, so that said maleic acid copolymer comprises at least approximately 50 mole percent maleic acid and up to 50 mole percent free radical polymerized co-monomers.

14. A system comprising:
a circulating water system comprising:
a heat exchanger;
a cooling tower;
water lines configured to circulate a circulating water stream, and comprising a first circulating water line configured to circulate a portion of the circulating water stream comprising relatively cooler water from the cooling tower to the heat exchanger and a second circulating water line configured to circulate another portion of the circulating water stream comprising relatively hotter water from the heat exchanger to the cooling tower; and
a dosing system comprising one or more dosing apparatus configured to add one or more components of a corrosion inhibitor to the circulating water stream, wherein at least one of the one or more dosing apparatus contains a phosphate-free corrosion inhibitor (PFCI) and is configured to add the PFCI to the circulating water stream, wherein the corrosion inhibitor comprises a polymaleic acid copolymer and optionally a metal.

15. The system of claim 14 wherein the one or more components include a metal, and wherein the at least one of the one or more dosing apparatus containing the PFCI is configured to add the PFCI to the circulating water stream such that the circulating water stream has a PFCI concentration in a range of from greater than zero to about 15 ppm.

16. The system of claim 15, wherein the dosing system is configured to add the metal to the circulating water stream such that the circulating water stream has a metal concentration in a range of from greater than zero to about 5 ppm.

17. The system of claim 14, wherein the one or more components do not include a metal, and wherein the at least one of the one or more dosing apparatus containing the PFCI is configured to add the PFCI to the circulating water stream such that the circulating water stream has a PFCI concentration in a range of from about 20 to about 100 ppm.

18. The system of claim 14, wherein the corrosion inhibitor consists essentially of the PFCI and optionally the metal.

19. The system of claim 14, wherein the polymaleic acid copolymer comprises at least 5 mole percent decarboxylated maleic acid repeating units.

20. The system according to claim 14, wherein the polymaleic acid copolymer comprises:
mono-carboxylic acids,
terminal hydroxyl groups, and
non-ionic functional groups which aid in adsorption onto a metal surface,
wherein said non-ionic functional groups and said terminal hydroxyl groups are formed during an aqueous polymerization process, and wherein the maleic acid copolymer comprises at least approximately 50 mole percent maleic acid and up to 50 mole percent free radical polymerized co-monomers.
